(19) United States
(12) Patent Application Publication
(10) Pub. No.: US 2025/0121414 A1
(43) Pub. Date: Apr. 17, 2025

(54) HIGH-PRESSURE WASHER

(71) Applicant: KT&G CORPORATION, Daejeon (KR)

(72) Inventors: Jung Mo KIM, Busan (KR); Jae Seok LEE, Daejeon (KR)

(73) Assignee: KT&G CORPORATION, Daejeon (KR)

(21) Appl. No.: 18/834,103

(22) PCT Filed: Mar. 30, 2023
(86) PCT No.: PCT/KR2023/004246

§ 371 Date: Jul. 29, 2024

(30) Foreign Application Priority Data
Mar. 30, 2022 (KR) 10-2022-0039311
Mar. 24, 2023 (KR) 10-2023-0038728

(51) Int. Cl. B08B 3/02; B05B 1/14

(52) U.S. Cl. CPC B08B 3/02; B05B 1/14

(57) ABSTRACT

A high-pressure washer comprises: a main body; a cover covering the top of the main body; a washing tank formed between the main body and the cover; a washing assembly disposed inside the washing tank and comprising a base on which an object to be washed is placed and a first washing module for cleaning the object to be washed; a water storage tank formed below the washing tank; and a water cleaning module disposed inside the water storage tank, wherein washing liquid which has washed the object to be washed is returned to the water storage tank and then is filtered and reused, and the water cleaning module may comprise a suction port formed at a height corresponding to a water surface level of the washing liquid stored in the water storage tank, and a discharge port for discharging floating matter introduced into the suction port to the outside.

### TECHNICAL FIELD

The following embodiments relate to a high-pressure washer.

### BACKGROUND ART

In general, cigarette machines, packaging machines, and low ignition propensity (LIP) coating units, which frequently use adhesives in industrial settings, utilize the adhesive supply nozzles of the adhesive application device to supply glue-type adhesives, thereby adhesively packaging objects to be packaged. Drums used for storing adhesives and/or coating agents in adhesive and coating agent application devices are prone to contamination due to various substances scattering during the production process, so the drums need to be cleaned at regular intervals. In particular, because adhesives and coating agents have strong adhesive properties and solidify over time, simply impregnating a drum in a cleaning liquid is not enough to keep the drum clean. Therefore, cleaning requires using a powerful cleaning liquid.

### DISCLOSURE OF THE INVENTION

### Technical Goals

An embodiment provides a high-pressure cleaning device that reduces contamination and other issues caused by solidified adhesives by cleaning parts to which adhesive materials are applied at regular intervals.

An embodiment provides a high-pressure washer that filters a cleaning liquid sucked from a water tank in a filtration device and then circulates the cleaning liquid as a cleaning liquid, thereby reducing the waste of the cleaning liquid by allowing the water in the water tank to be used repeatedly.

### Technical Solutions

A high-pressure washer according to various embodiments includes a main body, a cover configured to cover an upper portion of the main body, a washing tank formed between the main body and the cover, a washing assembly disposed in the washing tank and including a base in which an object to be washed is disposed and a first washing module configured to clean the object to be washed, a water storage tank formed on a lower portion of the washing tank, and a water cleaning module disposed in the water storage tank, wherein a washing liquid that washes the object to be washed is returned to the water storage tank, filtered, and reused, and the water cleaning module includes a suction port formed at a height corresponding to a water surface level of the washing liquid stored in the water storage tank and a discharge port configured to discharge floating matter introduced into the suction port to outside.

In an embodiment, the high-pressure washer may further include a circulation port that is in fluid communication with the water storage tank, wherein the circulation port is configured to transport, to a filter device, the washing liquid returned to the water storage tank.

In an embodiment, the high-pressure washer may further include a control module, wherein the control module may be configured to operate the water cleaning module when a predetermined time or a predetermined number of cleaning cycles is reached.

In an embodiment, the high-pressure washer may further include a heater disposed in the water storage tank and configured to heat the washing liquid.

In an embodiment, the first washing module may include a washing liquid supply pipe, a rotating disk including a first surface perpendicular to a longitudinal direction of the washing liquid supply pipe, a second surface formed on a side opposite to the first surface, and a side surface formed between the first surface and the second surface, a plurality of cleaning nozzles formed parallel to a rotation shaft of the rotating disk, and a plurality of propulsion nozzles formed to be inclined to the rotation shaft of the rotating disk, and the rotating disk may rotate around the washing liquid supply pipe due to spraying from the plurality of propulsion nozzles.

In an embodiment, the washing liquid supply pipe may be formed perpendicular to the base.

In an embodiment, the plurality of cleaning nozzles may extend in a vertical direction from the second surface of the rotating disk.

In an embodiment, the plurality of propulsion nozzles may be disposed on the side surface of the rotating disk and formed to be inclined to the rotation shaft of the rotating disk.

In an embodiment, angles formed between the plurality of propulsion nozzles and the rotation shaft are adjustable.

In an embodiment, the high-pressure washer may further include a second washing module, wherein the second washing module includes a spray stem extending upward in the washing tank and through which a washing liquid moves, a spray branch extending outward from the spray stem, and a spray nozzle disposed at an end of the spray branch.

In an embodiment, the spray branch may extend in a direction traversing a longitudinal direction of the spray stem, and the spray nozzle may face the object to be washed.

In an embodiment, the high-pressure washer may further include a jig configured to fix the object to be washed to the base.

### Effects of the Invention

The high-pressure cleaning device according to an embodiment may filter a cleaning liquid sucked from a water tank in a filtration device and then circulate it as a cleaning liquid, thereby reducing the waste of the cleaning liquid by allowing the water in the water tank to be used repeatedly.

A high-pressure cleaning device according to an embodiment may reduce contamination and other issues caused by solidified adhesives by cleaning parts to which adhesive materials (e.g., an adhesives, a coating agent, etc.) are applied at regular intervals.

The effects of the high-pressure washer according to an embodiment are not limited to the above-mentioned effects, and other unmentioned effects can be clearly understood from the above description by those having ordinary skill in the technical field to which the present disclosure pertains.

### BRIEF DESCRIPTION OF DRAWINGS

FIG. 1 is a schematic perspective view of a high-pressure washer according to an embodiment.

FIG. 2 is a schematic rear view of a high-pressure washer according to an embodiment.

FIG. 3 is a schematic cross-sectional view of a high-pressure washer according to an embodiment.

FIG. 4A is an enlarged view of a washing tank of the high-pressure washer illustrated in FIG. 3, according to an embodiment.

FIG. 4B is a front view of a first washing module according to an embodiment.

FIG. 5 is a schematic view illustrating a rotation mechanism of a first washing module, according to an embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In the following embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In the following embodiments, “upward” or “upper” refers to a direction (e.g., +Z direction in the drawing) away from the bottom surface or a portion located in that direction, and “downward” or “lower” refers to a direction (e.g., −Z direction in the drawing) toward the bottom surface or a portion located in that direction. The terms “upper” and “lower” may be used to describe relative positions of components of the high-pressure cleaning device.

In the following embodiments, “Blueband” refers to low ignition propensity (LIP) tobacco manufacturing technology, indicating a natural special substance coated on the outer or inner surface of a cigarette paper (wrapper). Furthermore, “Blueband coating process” refers to the process of coating the outer or inner surface of the cigarette paper (wrapper) of an aerosol generating article with a natural special substance.

An embodiment may be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

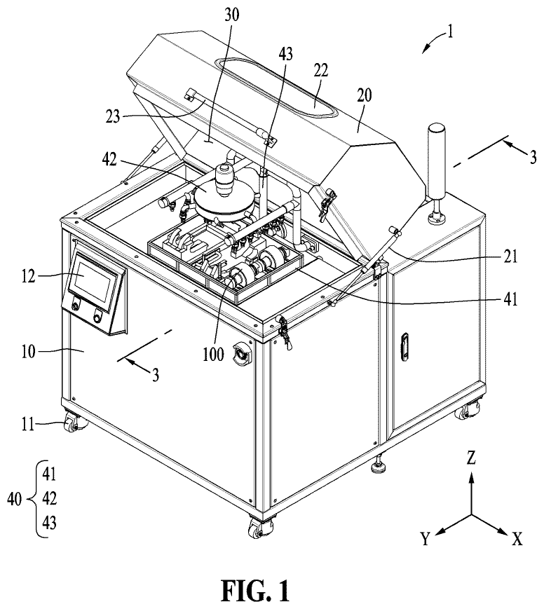

FIG. 1 is a schematic perspective view of a high-pressure washer 1, according to an embodiment.

Referring to FIG. 1, the high-pressure washer 1 may include a main body 10, a cover 20, a washing tank 30, and a washing assembly 40.

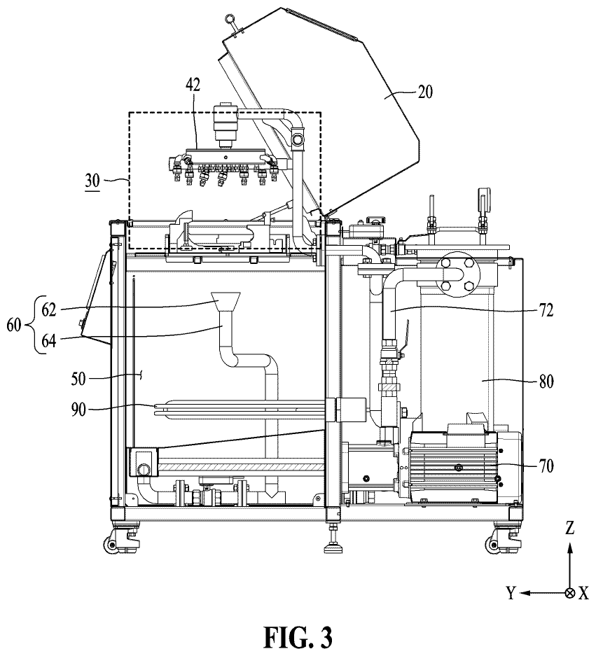

In an embodiment, the main body 10 may be formed of a sturdy material to protect some components included in the high-pressure washer 1. The main body 10 according to an embodiment may be formed in a hexahedral shape. The main body 10 may include a water storage tank (e.g., a water storage tank 50 of FIG. 3). The main body 10 according to an embodiment may include a wheel 11 on the bottom. The wheel 11 may facilitate the movement of the heavy high-pressure washer 1. The main body 10 according to an embodiment may include a screen 12. The screen 12 may display the operational status and monitoring control alarms of the high-pressure cleaning device 1, such as cleaning liquid pressure, cleaning liquid temperature, filter pressure, cleaning time, water level control, and the number of cleaning liquid replacements. The screen 12 may include a touch panel, so a user may control the operational status through the touch panel.

In an embodiment, the cover 20 may be disposed to cover the upper portion of the main body 10. The cover 20 may be hinged to the upper portion of the main body 10 and may open and close. A side surface of the cover 20 may be connected to the main body 10 by a cylinder 21. The cylinder 21 may be driven hydraulically or pneumatically: In an embodiment, the cover 20 may further include a window 22. The window 22 may be formed of a transparent or translucent material such as glass or acrylic. The user may easily check the cleaning status inside the washing tank 30 through the window 22. In an embodiment, the cover 20 may further include a handle 23. The user may easily open and close the cover 20 by holding the handle 23.

In an embodiment, the washing tank 30 may include a space formed between the main body 10 and the cover 20. The washing tank 30 may be a space in which actual cleaning of an object to be washed 100. In an embodiment, the object to be washed 100 may include a plurality of parts with complex shapes. The object to be washed 100 may include a cigarette packaging machine, a Blueband packaging machine, a drum, and the like used in the manufacturing process of tobacco, particularly cigarettes.

The washing assembly 40 may be disposed in the washing tank 30. Although not shown, two or more washing assemblies 40 may be disposed in the washing tank 30. The washing tank 30 may further include a drainage hole (not shown) disposed on the bottom surface of the washing tank 30. A washing liquid sprayed onto the object to be washed 100 by the washing assembly 40 may be returned to a water storage tank (e.g., the water storage tank 50 of FIG. 3) in the main body through the drainage hole.

In an embodiment, the washing assembly 40 may include a base 41, a first washing module 42, and a second washing module 43. The base 41 may be formed so that the object to be washed 100 is disposed therein.

The base 41 may be disposed on one side of the bottom surface (e.g., the bottom surface on the +X side in FIG. 1) of the washing tank 30. The base 41 may be formed to have an engraved shape corresponding to the appearance of the object to be washed 100, so that the object to be washed 100 may be stably fixed. When the object to be washed 100 includes a plurality of parts, the base 41 may be formed to include a plurality of engraved shapes corresponding to the appearances of the respective parts.

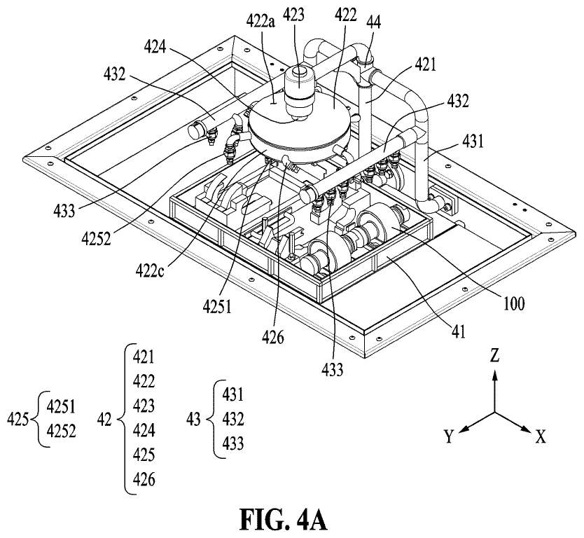

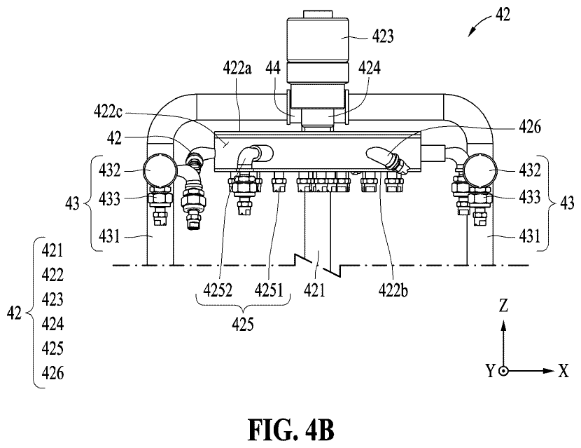

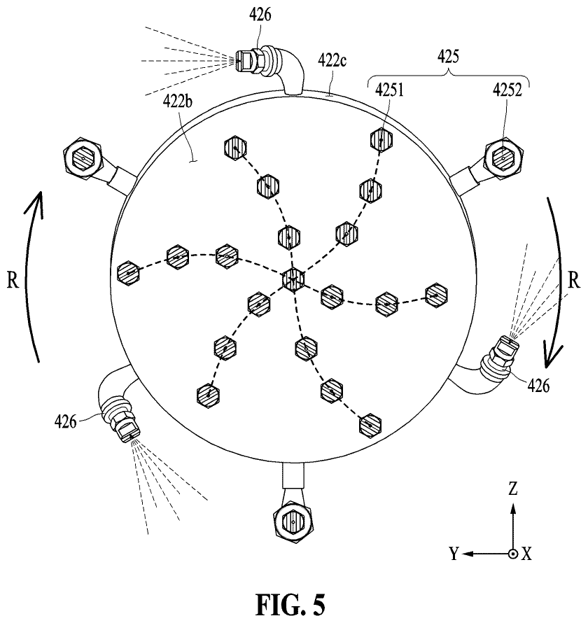

The first washing module 42 may be disposed on the bottom surface (e.g., the bottom surface on the −X side in FIG. 1) opposite to the base 41. The first washing module 42 may spray a high-pressure washing liquid toward the object to be washed 100 fixed to the base 41. The first washing module 42 may spray a high-pressure washing liquid while rotating on a plane perpendicular to the spraying direction with respect to the object to be washed 100. In an embodiment, the first washing module 42 may rotate by electric power. In another embodiment, the first washing module 42 may rotate according to the action-reaction effect caused by the washing liquid sprayed from a propulsion nozzle (e.g., a propulsion nozzle 426 of FIG. 5). The components and the driving method of the first washing module 42 are described in more detail below with reference to FIGS. 4A, 4B, and 5.

The second washing module 43 may be formed to extend upward (e.g., +Z direction in FIG. 1) from the bottom surface adjacent to the base 41. The second washing module 43 may spray a washing liquid toward the object to be washed 100 together with the first washing module 42. The components and the driving method of the second washing module 43 are described in more detail below with reference to FIGS. 4A and 4B.

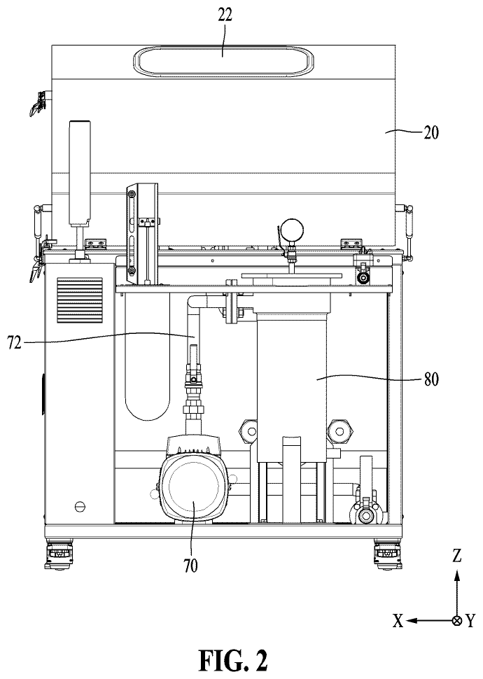

FIG. 2 is a schematic rear view of the high-pressure washer 1 according to an embodiment.

Referring to FIG. 2, the high-pressure washer 1 may further include a pump 70 and a filter device 80.

In an embodiment, the pump 70 may suck a washing liquid from a water storage tank (e.g., the water storage tank 50 of FIG. 3) through a circulation port 72 and transport the washing liquid to the filter device 80. The washing liquid filtered by the filter device 80 may be supplied to the water storage tank (e.g., the water storage tank 50 of FIG. 3) through the circulation port 72. The pump 70 may supply the washing liquid purified by the filter device 80 back to the washing assembly 40.

In an embodiment, the filter device 80 may filter a washing liquid used to wash an object to be washed (e.g., the object to be washed 100 of FIG. 1) in a washing tank (e.g., the washing tank 30 of FIG. 1). The washing liquid filtered by the filter device 80 may be sprayed back into the washing tank 30 through the washing assembly 40. The filter device 80 may include at least one filtering element, such as a filter screen, a sedimentation filter, an activated carbon filter, an osmotic pressure filter, and a high efficiency particulate air (HEPA) filter. The filtering element included in the filter device 80 according to an embodiment may be replaced after being used approximately 1,000 times.

In an embodiment, the washing liquid may be repeatedly reused while circulating through the water storage tank 50 and the filter device 80 by the pump 70. In this case, the number of repeated uses of the washing liquid may be determined depending on the type and shape of a glue part. For example, when a drum-shaped object to be washed 100 is cleaned, the washing liquid may be reused approximately 100 times.

FIG. 3 is a schematic cross-sectional view of the high-pressure washer 1 of FIG. 1 taken along line 3-3′, according to an embodiment. Referring to FIG. 3, the high-pressure washer 1 according to an embodiment may further include the water storage tank 50, a water cleaning module 60, and a heater 90.

In an embodiment, the water storage tank 50 may be formed on the bottom of the washing tank 30. The water storage tank 50 may store the washing liquid supplied to the washing module 42. The heater 90 may be disposed in an inner space of the water storage tank 50. The heater 90 may be an electrically operated heater. The heater 90 may heat a washing liquid. The heater 90 may further include a temperature sensor (not shown), and the temperature sensor may detect the temperature of the a washing liquid inside the water storage tank 50 to ensure a constant temperature is maintained. In an embodiment, the water storage tank 50 may be partitioned from other components (e.g., the pump 70, the filter device 80, etc.) of the high-pressure washer 1. Since the water storage tank 50 is a space for storing a washing liquid, it is desirable that electronic components sensitive to water or foreign substances are placed away from the water storage tank 50. In an embodiment, the washing liquid sprayed by the first washing module 42 and/or a second washing module (e.g., the second washing module 43 of FIG. 4A and/or FIG. 4B) may wash the object to be washed 100, and the washing liquid contaminated by washing the object to be washed 100 may be returned to the water storage tank 50. The contaminated washing liquid in the water storage tank 50 may be moved to the filter device 80 and filtered.

Continuously referring to FIG. 3, the water cleaning module 60 may be disposed in the water storage tank 50. The water cleaning module 60 may include an suction port 62 and a discharge port 64. The height of the suction port 62 may be disposed to correspond to the water surface level of the washing liquid stored in the water storage tank 50. As the washing liquid used for washing the object to be washed 100 falls from the washing tank 30 to the water storage tank 50 due to gravity, waves may be formed on the surface of the washing liquid stored in the water storage tank 50. Due to the waves of the washing liquid, floating matters may overflow into the suction port 62 of the water cleaning module 60. The floating matters (e.g., glue product residue, foreign substances, etc.) introduced into the suction port 62 may move along the discharge port 64 connected to the suction port 62 and may be discharged to the outside of a high-pressure washer (e.g., the high-pressure washer 1 of FIG. 1). In an embodiment, the water cleaning module 60 may operate automatically at predetermined time intervals. In an embodiment, the water cleaning module 60 may operate only when the object to be washed 100 is not coupled to a jig (not shown) of a base (e.g., the base 41 of FIG. 1). The cycle, duration, and the like of the automatic operation of the water cleaning module 60 may be viewed and controlled through a screen (e.g., the screen 12 of FIG. 1) of the high-pressure cleaning device (e.g., the high-pressure cleaning device 1 of FIG. 1).

FIG. 4A is an enlarged view of the washing tank 30 of the high-pressure washer 1 of FIG. 3, according to an embodiment. FIG. 4B is a schematic front view of the washing tank 30 according to an embodiment.

FIG. 5 is a schematic view illustrating a rotation mechanism of the first washing module 42, according to an embodiment.

Referring to FIGS. 4A, 4B and/or 5, the first washing module 42 may include a washing liquid supply pipe 421, a rotating disk 422, a rotary joint 423, a rotating pipe 424, a cleaning nozzle 425, and a propulsion nozzle 426. In an embodiment, the washing liquid supply pipe 421 may include a conduit for transferring a washing liquid in a water storage tank (e.g., the water storage tank 50 of FIG. 3). The washing liquid supply pipe 421 may transfer the washing liquid filtered by a filter device (e.g., the filter device 80 of FIG. 3) to a space inside the rotating disk 422.

In an embodiment, the rotating disk 422 may be in fluid communication with the washing liquid supply pipe 421 and may include a circular cross-section perpendicular to the longitudinal direction of the washing liquid supply pipe 421. For example, the rotating disk 422 may include a first surface 422a in contact with the rotating pipe 424, a second surface 422b formed on a side opposite to the first surface 422a, and a side surface 422c formed between the first surface 422a and the second surface 422b and formed to surround the edges of the first surface 422a and the second surface 422b. The rotating disk 422 may rotate on a plane perpendicular to the rotating pipe 424. The rotation shaft of the rotating disk 422 may be formed parallel to the longitudinal direction of the rotating pipe 424. The rotating disk 422 may include a space for storing a washing liquid therein.

In an embodiment, the rotary joint 423 may serve as a joint so that the rotating disk 422 may easily rotate with respect to the washing liquid supply pipe 421. For example, the rotary joint 423 may include a bearing (not shown) therein. For example, the bearing included in the rotary joint 423 may include a ball bearing, a roller bearing, an oil bearing, and the like.

In an embodiment, the rotating pipe 424 may include a path through which the washing liquid is transferred to the rotating disk 422. The rotating pipe 424 may enable the rotating disk 422 to be in fluid communication with the rotary joint 423. The rotating pipe 424 may be formed perpendicular to the bottom surface on which a base (e.g., the base 41 of FIG. 1) is disposed. For example, the rotating pipe 424 may transfer the washing liquid in a direction toward the bottom surface.

In an embodiment, the cleaning nozzle 425 may be formed in a direction parallel to the rotation shaft of the rotating disk 422 (e.g., −Z direction in FIGS. 4A and 4B). For example, the cleaning nozzle 425 may spray a washing liquid in a direction parallel to the rotation shaft of the rotating disk 422. The cleaning nozzle 425 may include a first cleaning nozzle 4251 and a second cleaning nozzle 4252. The first cleaning nozzle 4251 may be disposed on the second surface 422b of the rotating disk 422 and may extend in the direction (e.g., −Z direction in FIGS. 4A and 4B) perpendicular to the second surface 422b. Since the first cleaning nozzle 4251 sprays the washing liquid in the same direction as the moving direction of the washing liquid transferred through the rotating pipe 424, the spray pressure of the washing liquid may be higher than that of the second cleaning nozzle 4252. A plurality of first cleaning nozzles 4251 may form a predetermined pattern and be disposed on the second surface 422b of the rotating disk 422. For example, the plurality of first cleaning nozzles 4251 may be disposed on the second surface 422b of the rotating disk 422 in a pinwheel pattern that is convex in the rotation direction of the rotating disk 422.

The second cleaning nozzle 4252 may be disposed on the side surface 422c of the rotating disk 422, may extend in the direction (e.g., +/−X direction or +/−Y direction of FIG. 4A and/or FIG. 4B) perpendicular to the side surface 422c, and may be bent in the direction (e.g., −Z direction of FIG. 4A and/or FIG. 4B) parallel to the side surface 422c. For example, the second cleaning nozzle 4252 may spray the washing liquid in the same direction as the first cleaning nozzle 4251 (e.g., −Z direction in FIG. 4A and/or FIG. 4B).

In an embodiment, the propulsion nozzle 426 may be formed to be inclined with respect to the rotation shaft of the rotating disk 422. In another embodiment, the propulsion nozzle 426 may be formed in the direction perpendicular to the rotation shaft of the rotating disk 422. The propulsion nozzle 426 may be formed on the side surface 422c of the rotating disk 422. As the washing liquid is discharged at high pressure through the propulsion nozzle 426, the action-reaction effect caused by the rotating propulsion nozzle 426, which is attached at a predetermined angle, exerts force on the rotating disk 422 in the direction (e.g., the direction of arrow R in FIG. 5) opposite to the discharge of the washing liquid from the propulsion nozzle 426. Consequently, the rotating disk 422 rotates. In other words, when the washing liquid is sprayed toward the object to be washed 100 from the first washing module 42, the washing liquid with strong spray pressure rotates and is sprayed from the plurality of cleaning nozzles 425 disposed to communicate with the inner space of the rotating disk 422. This ensures that the entire surface of the object to be washed 100 is washed thoroughly. For example, instead of spraying the washing liquid at a predetermined position while the cleaning nozzle 425 is stationary, the washing liquid may be sprayed while the rotating disk 422 rotates due to the rotational force of the fluid. In particular, a plurality of cleaning nozzles 425 grouped together may spray the washing liquid simultaneously, thoroughly cleaning the entire surface of the object to be washed 100 and removing foreign substances without missing any spots, thereby enhancing the washing effect. In an embodiment, the propulsion nozzle 426 may be formed in plurality: The propulsion nozzles 426 may be disposed at predetermined intervals on the side surface 422c of the rotating disk 422. The angle between the propulsion nozzle 426 and the first surface 422a of the rotating disk 422 is adjustable. The rotational force transmitted to the rotating disk 422 by spraying from the propulsion nozzle 426 may vary depending on the angle between the propulsion nozzle 426 and the first surface 422a. Accordingly, the rotation velocity of the rotating disk 422 may be adjusted. For example, the closer the angle between the propulsion nozzle 426 and the first surface 422a is to 0 degrees, the faster the rotating disk 422 rotates, while the closer the angle between the propulsion nozzle 426 and the first surface 422a is to 90 degrees, the slower the rotating disk 422 rotates.

At least a portion of the washing liquid sprayed from the cleaning nozzle 425 and the propulsion nozzle 426 of the first washing module 42 according to an embodiment may be sprayed toward the object to be washed 100. More particularly, the washing liquid sprayed from the cleaning nozzle 425 and the propulsion nozzle 426 of the first washing module 42 rotates and is sprayed toward the object to be washed 100, thereby evenly cleaning the entire object to be washed 100, which is contaminated due to the storage of adhesives and the like.

Continuously referring to FIGS. 4A and 4B, the washing assembly 40 may further include the second washing module 43. The second washing module 43 may include a spray stem 431, a spray branch 432, and a spray nozzle 433. The spray stem 431 may extend upward (e.g., +Z direction of FIG. 4A) in a washing tank (e.g., the washing tank 30 of FIG. 3) and may include a path along which the washing liquid in the water storage tank 50 moves. The spray branch 432 may be formed to extend outward (e.g., +Y direction of FIG. 4A) from the spray stem 431 and may include a path for moving the washing liquid from the spray stem 431 to the spray nozzle 433. The spray branch 432 may extend in the direction traversing the longitudinal direction of the spray stem 431. For example, the spray branch 432 may extend in the direction (e.g., +/−Y direction or +/−X direction in FIG. 4A and/or FIG. 4B) perpendicular to the longitudinal direction (e.g., +Z direction in FIG. 4A and/or FIG. 4B) of the spray stem 431. The spray nozzle 433 may be disposed at an end of the spray branch 432 to spray the washing liquid toward the object to be washed 100. The second washing module 43 may be disposed together with the first washing module 42 to remove contamination from the object to be washed 100.

Referring to FIGS. 4A and 4B, the washing assembly 40 may further include a supply pipe joint 44. The supply pipe joint 44 may connect the washing water supply pipe 421 of the first washing module 42 to the spray stem 431 of the second washing module 43. The supply pipe joint 44 may collect the washing liquid supplied from the water storage tank 50 in one place, thereby allowing the washing liquid sprayed from the first washing module 42 and the second washing module 43 to have uniform spray pressure.

In an embodiment, the washing assembly 40 may further include a jig (not shown) for fixing the object to be washed 100 to the base 41, and the jig may be in contact with the inner wall of the object to be washed 100 to securely fix the object to be washed 100 to the base 41.

Hereinafter, a method of operating the high-pressure washer 1 according to an embodiment is described as an example with reference to FIGS. 1 to 5. The high-pressure washer 1 may start operating when the cover 20 is closed after the object to be washed 100 is attached to the base 41. The pump 70 according to an embodiment may pull the cleaning liquid stored in the water storage tank 50 and transport the washing liquid to the washing assembly 40. The washing liquid transported to the washing assembly 40 may be sprayed onto the object to be washed 100 by the first washing module 42 and the second washing module 43. While the washing liquid is sprayed onto the object to be washed 100, the first washing module 42 may rotate around one axis in the opposite direction of the high-pressure liquid sprayed from the propulsion nozzle 426 to easily clean the entire surface of the object to be cleaned 100. The washing liquid used to wash the object to be washed 100 may fall downward due to gravity and may be returned to the water storage tank 50. The washing liquid returned to the water storage tank 50 may contain glue residue and other contaminants, and these contaminants may be self-cleaned by being discharged to the outside of the high-pressure washer 1 by the water cleaning module 60. The washing liquid in the water storage tank 50 may be moved to the filter device 80 by the pump 70, filtered, and then transferred to the washing assembly 40. Through the above series of processes, the high-pressure washer 1 using a reusable washing liquid may operate. The series of operations of the high-pressure cleaning device 1 may be controlled by a user through a touch panel included in the screen 12 according to FIG. 1.

Conventionally, to remove adhesives and coating agents adhered to the object to be washed 100, such as an LIP coating unit, a drum, and a cigarette packaging machine, hot water is supplied to the object to be washed 100 for a predetermined period of time to soften the adhered adhesives and coating agents, followed by manual cleaning by workers. This process results in high consumption of cleaning liquid, long cleaning times, and increased energy waste due to gas usage for heating the water. By utilizing the high-pressure washer 1 and the cleaning method using the high-pressure washer 1, it may be possible to reduce the waste of washing liquid and achieve even cleaner outcomes.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents of the claims are within the scope of the following claims.

1. A high-pressure washer comprising:
a main body;
a cover configured to cover an upper portion of the main body;
a washing tank formed between the main body and the cover;
a washing assembly disposed in the washing tank and comprising a base in which an object to be washed is disposed and a first washing module configured to clean the object to be washed;
a water storage tank formed on a lower portion of the washing tank; and
a water cleaning module disposed in the water storage tank,
wherein a washing liquid that washes the object to be washed is returned to the water storage tank, filtered, and reused, and the water cleaning module comprises a suction port formed at a height corresponding to a water surface level of the washing liquid stored in the water storage tank and a discharge port configured to discharge floating matter introduced into the suction port to outside.

2. The high-pressure washer of claim 1, further comprising a circulation port that is in fluid communication with the water storage tank,
wherein the circulation port is configured to transport, to a filter device,
the washing liquid returned to the water storage tank.

3. The high-pressure washer of claim 1, further comprising:
a control module,
wherein the control module is configured to operate the water cleaning module when a predetermined time or a predetermined number of cleaning cycles is reached.

4. The high-pressure washer of claim 1, further comprising a heater disposed in the water storage tank and configured to heat the washing liquid.

5. The high-pressure washer of claim 1, wherein
the first washing module comprises:
a washing liquid supply pipe;
a rotating disk comprising a first surface perpendicular to a longitudinal direction of the washing liquid supply pipe, a second surface formed on a side opposite to the first surface, and a side surface formed between the first surface and the second surface;
a plurality of cleaning nozzles formed parallel to a rotation shaft of the rotating disk; and
a plurality of propulsion nozzles formed to be inclined to the rotation shaft of the rotating disk, and
the rotating disk rotates around the washing liquid supply pipe due to spraying from the plurality of propulsion nozzles.

6. The high-pressure washer of claim 5, wherein the washing liquid supply pipe is formed perpendicular to the base.

7. The high-pressure washer of claim 5, wherein the plurality of cleaning nozzles extends in a vertical direction from the second surface of the rotating disk.

8. The high-pressure washer of claim 5, wherein
the plurality of propulsion nozzles is disposed on the side surface of the rotating disk and formed to be inclined to the rotation shaft of the rotating disk.

9. The high-pressure washer of claim 8, wherein angles formed between the plurality of propulsion nozzles and the rotation shaft are adjustable.

10. The high-pressure washer of claim 1, further comprising
a second washing module,
wherein the second washing module comprises:
a spray stem extending upward in the washing tank and through which a washing liquid moves;
a spray branch extending outward from the spray stem; and
a spray nozzle disposed at an end of the spray branch.

11. The high-pressure washer of claim 10, wherein
the spray branch extends in a direction traversing a longitudinal direction of the spray stem, and
the spray nozzle faces the object to be washed.

12. The high-pressure washer of claim 1, further comprising:
a jig configured to fix the object to be washed to the base.
